(19) United States
(12) Patent Application Publication
(10) Pub. No.: US 2014/0136486 A1
(43) Pub. Date: May 15, 2014

(54) METHOD AND SYSTEM FOR DATA LIFECYCLE MANAGEMENT OF MANUFACTURING TEST DATA

(71) Applicants: Nicolas ROY, St-Lambert (CA); Philippe DESAULNIERS, Mont Saint-Hilaire (CA); Pascal PILON, Montreal (CA)

(72) Inventors: Nicolas ROY, St-Lambert (CA); Philippe DESAULNIERS, Mont Saint-Hilaire (CA); Pascal PILON, Montreal (CA)

(21) Appl. No.: 13/677,502

(22) Filed: Nov. 15, 2012

(51) Int. Cl. G06F 17/30

(52) U.S. Cl. CPC G06F 17/30073
USPC 707/667; 707/736

(57) ABSTRACT

The present invention relates to a method and system for data lifecycle management of manufacturing test data. The method and system receive, at an acquisition unit, manufacturing test data from at least one source, process the manufacturing test data for rendering the manufacturing test data compatible with a digital storage system, and load the manufacturing test data into a digital storage system. The method and system further store, at the digital storage system, the manufacturing test data; and monitor an amount of data stored in the digital storage system corresponding to at least one type of active data. An alert is generated when the monitored amount of data is above a pre-defined alert threshold. Access to a pre-defined subset of data stored in the digital storage system is blocked, when the monitored amount of data is above a pre-defined blocking threshold.

### TECHNICAL FIELD

The present disclosure relates to the field of data lifecycle management; and more particularly to data lifecycle management of manufacturing test data from multiple sources in a supply chain hierarchy.

### BACKGROUND

Manufacturing processes have become more and more complex, involving multiple contributors for the production of a final product. The final product is generally composed of a large number of components, manufactured by multiple contributors. Furthermore, a component manufactured by a contributor may include sub-components manufactured by another contributor.

One can refer to the notion of supply chain hierarchy, to represent the multiple contributors for the production of a product. The supply chain hierarchy includes an Original Equipment Manufacturer (OEM), in charge of the production of the product. The OEM has tier 1 suppliers, which manufacture components included in the product. Then, the tier 1 suppliers may have tier 2 suppliers, which manufacture components included in their own components, etc. This hierarchy, including the OEM and the various levels of tier I suppliers, is referred to as a multi level supply chain hierarchy.

The various components of the product are manufactured and tested by the multiple contributors of the supply chain hierarchy. In particular, manufacturing test data are generated at different levels of the supply chain hierarchy, by the multiple contributors. These manufacturing test data are usually aggregated in order to analyze them; for instance to determine a compliance of the various components with specifications, to detect defective components, etc.

The manufacturing test data constitute a large amount of complex and heterogeneous data. Furthermore, these data represent critical information in the context of a quality and compliance policy enforced for the whole supply chain hierarchy. However, the importance of a specific piece of information may vary over time, becoming less critical as time elapses. And the cost of maintaining information which is no longer critical may become prohibitive. There is therefore a need for a method and system for data lifecycle management of manufacturing test data.

### SUMMARY

According to a first aspect, the present disclosure provides a system for data lifecycle management of manufacturing test data. For doing so, the system comprises an acquisition unit for receiving manufacturing test data from at least one source, processing the manufacturing test data for rendering the manufacturing test data compatible with a digital storage system, and loading the manufacturing test data into the digital storage system. And the digital storage system for storing the manufacturing test data, and monitoring an amount of data stored in the digital storage system corresponding to at least one type of active data.

According to a second aspect, the present disclosure provides a method for data lifecycle management of manufacturing test data. For doing so, the method comprises receiving, at an acquisition unit, manufacturing test data from at least one source. The method comprises processing, at the acquisition unit, the manufacturing test data for rendering the manufacturing test data compatible with a digital storage system. The method comprises loading, at the acquisition unit, the manufacturing test data into the digital storage system. The method comprises storing, at the digital storage system, the manufacturing test data. And the method comprises monitoring, at the digital storage system, an amount of data stored in the digital storage system corresponding to at least one type of active data.

According to another aspect, an alert is generated when the amount of data stored in the digital storage system corresponding to the at least one type of active data is above a pre-defined alert threshold.

According to another aspect, access to a pre-defined subset of data stored in the digital storage system is blocked when the amount of data stored in the digital storage system corresponding to the at least one type of active data is above a pre-defined blocking threshold.

According to another aspect, the digital storage system implements a database for storing the manufacturing test data in an optimized format.

According to another aspect, the manufacturing test data comprise at least one of test data and quality data related to manufactured components.

According to another aspect, the system further comprises an analytic system for processing data stored in the database to generate at least one of test metrics and quality metrics related to the manufactured components.

According to another aspect, the system further comprises an archive system for transferring decommissioned data from the digital storage system to the archive system. The decommissioned data are no longer taken into consideration for calculating the amount of data stored in the digital storage system corresponding to the at least one type of active data.

According to another aspect, the decommissioned data are selected at the digital storage system by means of one of: a user interaction with the digital storage system or an automatic enforcement of an archiving policy to the data stored in the digital storage system.

According to another aspect, decommissioned data stored in the archive system are integrated to the digital storage system in the form of near line data; wherein the near line data are taken into consideration when monitoring the amount of data stored in the digital storage system corresponding to the at least one type of active data.

According to another aspect, a billing policy based on the amount of data stored in the digital storage system corresponding to the at least one type of active data is applied.

The foregoing and other features of the present method and system will become more apparent upon reading of the following non-restrictive description of examples of implementation thereof, given by way of illustration only with reference to the accompanying drawings.

### BRIEF DESCRIPTION OF THE DRAWINGS

In the appended drawings:

FIG. 1A illustrates a system for data lifecycle management of manufacturing test data, according to a non-restrictive illustrative embodiment;

FIG. 1B illustrates an acquisition unit and a digital storage system, according to a non-restrictive illustrative embodiment;

FIG. 2 further illustrates the system for data lifecycle management of manufacturing test data of FIG. 1A, according to a non-restrictive illustrative embodiment;

FIG. 3 illustrates a method for data lifecycle management of manufacturing test data, according to a non-restrictive illustrative embodiment; and

FIG. 4 further illustrates the method for data lifecycle management of manufacturing test data of FIG. 3, according to a non-restrictive illustrative embodiment.

### DETAILED DESCRIPTION

To better understand the present specification, the following definitions are provided.

Product/components: a product is a finalized manufactured item, produced at the final stage of a manufacturing process. A product may be composed of several components, the components being optionally composed of sub-components, etc. The components and sub-components are manufactured at intermediate stages of the manufacturing process. Thus, the product is composed of a hierarchy of components. A component of level 1 is included in a product, a component of level 2 is included in a component of level 1, etc. A sub-component refers to a component of level I+1 included in a component of level I.

OEM: Original Equipment Manufacturer. An OEM is an enterprise. It manufactures products that are purchased by another enterprise, and retailed under that purchasing enterprise's brand name. The OEM may purchase for use in its own products components made by other companies, referred to as tier suppliers in the present.

Tier supplier: a manufacturing entity manufacturing a component included in a product manufactured by an OEM.

Tier I supplier: a tier supplier of level I manufacturing a component of level I, included in a product manufactured by an OEM.

Multi level supply chain hierarchy: a supply chain environment composed of a hierarchy of enterprises, which collaborate to manufacture a product. The product is composed of a hierarchy of components. The multi level supply chain hierarchy comprises an OEM, which manufactures the product. And N levels of tier I suppliers, which respectively manufacture components of level I included in the product.

Member of the supply chain hierarchy: a specific enterprise with a specific role in the supply chain hierarchy. For example, a specific OEM or a specific tier I supplier.

Premises: a physical location of an enterprise of the multi level supply chain hierarchy. Equipment used for the manufacturing and testing of components of a product (or the product itself in the case of an OEM) are located at the premises of the enterprise.

The present relates to a system for data lifecycle management of manufacturing test data.

The system comprises an acquisition unit. The acquisition unit receives manufacturing test data from at least one source. The acquisition unit further processes the manufacturing test data, for rendering the manufacturing test data compatible with a digital storage system. And the acquisition unit loads the manufacturing test data into the digital storage system.

The system also comprises the digital storage system. The digital storage system stores the manufacturing test data. And the digital storage system monitors an amount of data, stored in the digital storage system, corresponding to at least one type of active data.

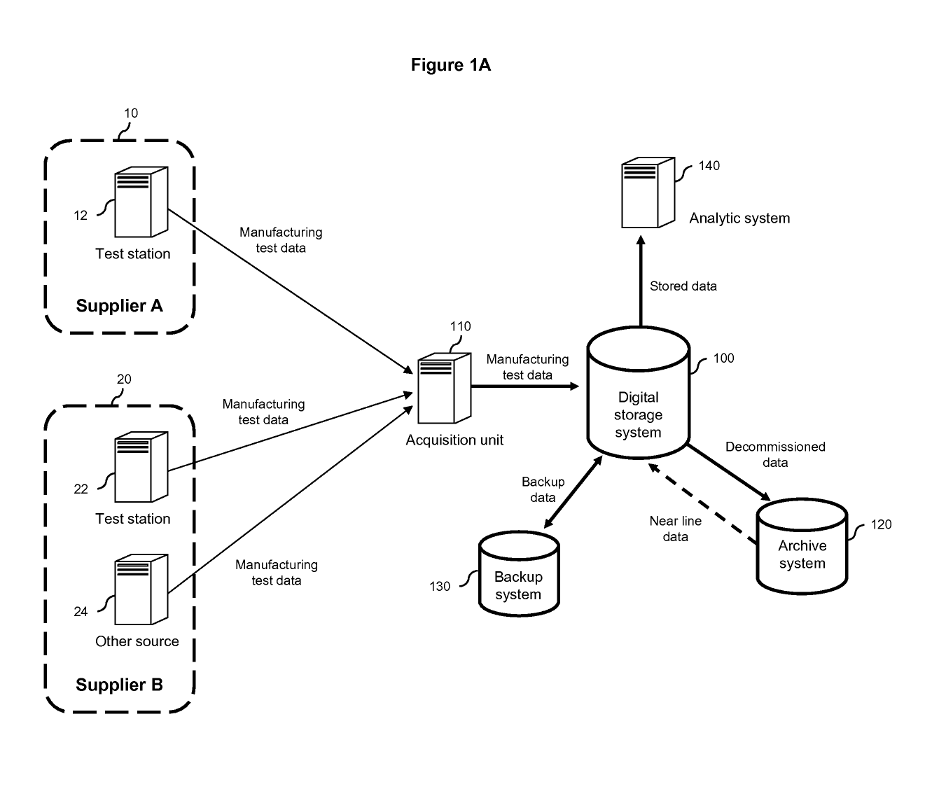

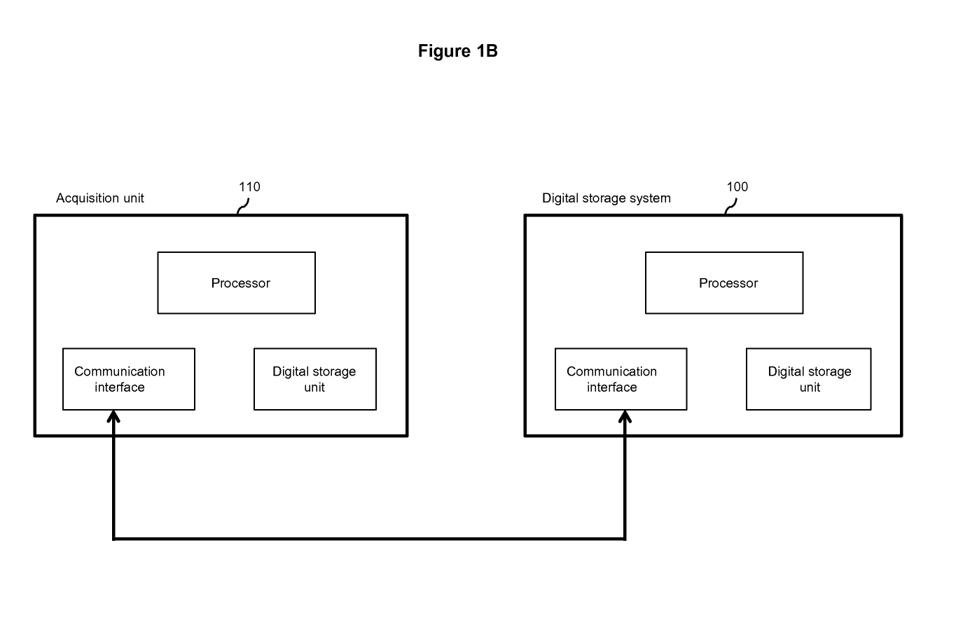

Referring now to FIG. 1A, a system for data lifecycle management of manufacturing test data is represented.

An acquisition unit 110, for receiving manufacturing test data from multiple sources, is represented in FIG. 1A. And a digital storage system 100, for storing the manufacturing test data, is represented in FIG. 1A.

The acquisition unit 110 receives manufacturing test data from a test station 12 located at premises 10 of a supplier A. The test station 12 performs tests on at least one type of component manufactured by supplier A. For each instance of a component tested by test stations 12, manufacturing test data are generated and transmitted from the test station 12 to the acquisition unit 110.

The acquisition unit 110 receives manufacturing test data from a test station 22 located at premises 20 of a supplier B. The test station 22 performs tests on at least one type of component manufactured by supplier B. For each instance of a component tested by test stations 22, manufacturing test data are generated and transmitted from the test station 22 to the acquisition unit 110.

The acquisition unit 110 also receives manufacturing test data from another source 24 located at the premises 20 of the supplier B. The other source 24 is not a test station, and the manufacturing test data from the other source 24 are not test data per se: they do not result from the testing of a component. However, the manufacturing test data from the other source 24 are complementary to manufacturing test data generated by a test station (for example test station 22). For example, the manufacturing test data from the other source 24 may contain information related to the components tested by test station 22; for example date of manufacture of the components, equipment used to manufacture the components, etc. This type of information may be useful to analyze the context in which several components present defaults and/or are not compliant with related specifications. In the rest of the present disclosure, the term manufacturing test data will be used in a generic manner. The term will include data generated by test stations (e.g. 12 and 22) and directly related to the test of components; and data generated by other sources (e.g. 24) and providing complementary information related to the components under test. Examples of other sources include Enterprise Resource Planning (ERP) systems, Product Lifecycle Management (PLM) systems, and Manufacturing Execution Systems (MES).

The acquisition unit 110 further processes the manufacturing test data received from the test stations 12 and 22, and from the other source 24. The processing consists in rendering the received manufacturing test data compatible with the digital storage system 100. In some cases, the received manufacturing test data may already be compatible, in which case the processing only consists in verifying that the data are compatible, and doing nothing more since the data are already compatible.

And the acquisition unit 110 loads the processed manufacturing test data into the digital storage system 100, where they are stored.

The digital storage system 100 monitors the amount of data stored, corresponding to at least one type of active data. The monitoring may be programmed to take place at a (configurable) pre-defined interval of time (e.g. every hour, every day, etc). An active type of data is a (configurable) pre-defined type of data. A data stored in the digital storage system 100, and corresponding to (one of) the active types(s) of data is taken into consideration for calculating the amount of data corresponding to the at least one type of active data. And a data stored in the digital storage system 100, but not corresponding to (one of) the active types(s) of data is not taken into consideration for the calculation.

In one embodiment, the system for data lifecycle management of manufacturing test data is deployed in a multi level supply chain hierarchy. The multi level supply chain hierarchy comprises at least one OEM and N levels of tier I suppliers, with N greater or equal to 1 and I varying from 1 to N. The OEM manufactures at least one product, composed of components (and sub-components) manufactured by tier I suppliers. Manufacturing test data related to a product are generated by the OEM; and manufacturing test data related to the components (and sub-components) of a product are generated by the tier I suppliers. All these manufacturing test data are transmitted to an acquisition unit, where they are processed; and further loaded in a digital storage system, where they are stored. The digital storage system monitors the stored data, with respect to at least one type of active data.

The hierarchy of components included in a product may consist of: hardware parts, software, and sub-systems. The physical components (hardware parts and sub-systems) which compose a product may be of one or several types, including: electrical components, optical components, electronic components, mechanical components, mechatronic components. A sub-system consists of hardware parts and/or software. A sub-system is designed to provide a specific set of functionalities. The assembly of the sub-systems of a product, and the interactions between the functionalities of these sub-systems, provides the global functionalities of the product. Thus, manufacturing test data may be generated by testing each sub-system individually, to verify the conformance of each sub-system with respect to its specific set of functionalities. And manufacturing test data may be generated by testing the assembly of the sub-systems of a product, to verify the conformance of the interactions between the sub-systems with respect to the global functionalities of the product.

For illustration purposes, and referring to FIG. 1A, supplier A may be an OEM, and the test station 12 located at the premises 10 of the OEM generates manufacturing test data related to a product manufactured by the OEM. And supplier B may be a tier 1 supplier, and the test station 22 located at the premises 20 of the tier 1 supplier generates manufacturing test data related to a component (of the product manufactured by the OEM) manufactured by the tier 1 supplier.

Alternatively, supplier A may be a tier 1 supplier, and the test station 12 located at the premises 10 of the tier 1 supplier generates manufacturing test data related to a component (of a product manufactured by an OEM) manufactured by the tier 1 supplier. And supplier B may be a tier 2 supplier, and the test station 22 located at the premises 20 of the tier 2 supplier generates manufacturing test data related to a sub-component (of the component manufactured by the tier 1 supplier) manufactured by the tier 2 supplier.

The system for data lifecycle management of manufacturing test data (including the acquisition unit 110 and the digital storage system 100) may be located at the OEM premises, since the OEM is responsible for ensuring the quality and conformance of the products it manufactures. Alternatively, the system for data lifecycle management of manufacturing test data may be located at the premises of a third party, to which the OEM has delegated the data lifecycle management of its manufacturing test data. For example, such a third party may implement a cloud based infrastructure for the data lifecycle management of the manufacturing test data of one or several OEM(s).

In a particular aspect of the system for data lifecycle management of manufacturing test data, an alert is generated when the amount of data stored in the digital storage system corresponding to the at least one type of active data is above a pre-defined alert threshold.

For example, the digital storage system 100 of FIG. 1A is configured with two types of active data: type_{—}1 and type_{—}2; and a pre-defined alert threshold of 500 Gigabytes. And the amount of data stored in the digital storage system 100 is monitored every hour. If the amount of data stored in the digital storage system 100 corresponding to type_{—}1 and type_{—}2 reaches 500 Gigabytes, an alert is generated. The alert consists in a notification via an electronic medium that the pre-defined alert threshold has been reach. The alert may consist in automatically sending a warning email to an administrator of the digital storage system 100. The alert may also consist in display a warning message on a user interface of the digital storage system 100. Several alert thresholds may be configured (e.g. 500, 550, 575 Gigabytes) to provide more flexibility in using the alerts to warn the users of the system; before implementing more coercive actions.

In another particular aspect of the system for data lifecycle management of manufacturing test data, access to a pre-defined subset of data stored in the digital storage system is blocked, when the amount of data stored in the digital storage system corresponding to the at least one type of active data is above a pre-defined blocking threshold.

Coming back to the previous example, the digital storage system 100 of FIG. 1A is further configured with a pre-defined blocking threshold of 600 Gigabytes; and a pre-defined subset of data stored in the digital storage system 100 corresponding to data of type type_{—}3. If the amount of data stored in the digital storage system 100 corresponding to type_{—}1 and type_{—}2 reaches 600 Gigabytes, the access to data of type type_{—}3 is blocked. The access may be blocked for internal access to these data (by a functionality of the digital storage system 100), as well as for external access to these data (e.g. by an analytic system 140 as represented in FIG. 1A). A blocking alert may also be generated, informing the administrator and/or the users of the system for data lifecycle management that a blocking policy in now enforced on data of type type_{—}3.

In a particular aspect of the system for data lifecycle management of manufacturing test data, the digital storage system implements a database for storing the manufacturing test data in an optimized format.

In another particular aspect of the system for data lifecycle management of manufacturing test data, the manufacturing test data comprise at least one of test data and quality data related to manufactured components.

Test data consist in a set of physical measures collected when testing a component. Test data are representative of the intrinsic attributes/characteristics of the component being tested.

Quality data consist in a set of data related to the manufacturing of a component. For instance, did the component pass or fail a specific test, which defects have been found on the component, etc.

The manufacturing test data may also include documents. Documents consist in miscellaneous types of files generated during the testing of components; and which are not formatted as structured data sets (the test data and quality data are usually formatted as structured data sets). Examples of documents include logs, execution traces, screen captures, etc.

In still another particular aspect of the system for data lifecycle management of manufacturing test data, the system comprises an analytic system for processing data stored in the database to generate at least one of test metrics and quality metrics related to the manufactured components.

Referring to FIG. 1A, the manufacturing test data received by the acquisition unit 110 include test data and quality data. The manufacturing test data are processed and rendered compatible with the optimized format of the database implemented by the digital storage system 100. The optimized format includes a data model, optimized for storing manufacturing test data related to multiple components of a product, manufactured by various tier suppliers of a supply chain hierarchy, over a period of time. Partitioning may be used for further format optimization. Partitioning is a technology well known in the art of database management. Partitioning facilitates the management of large tables of data (accumulated over time), and provides good query performance across these large tables. Also, data may be mapped to partitions based on date range (e.g. daily, weekly, monthly), to facilitate the decommissioning of data.

The processed manufacturing test data are loaded and stored in the database implemented by the digital storage system 100. Internal processing of the data stored in the digital storage system 100 may also be performed, to optimize the use of the stored data by external systems, like the analytic system 140. The analytic system 140 further processes the data stored in the digital storage system 100, to generate metrics, and reports based on the metrics. The metrics include test metrics and quality metrics related to the manufactured components. These metrics are based on the processing, by the analytic system 140, of the test data and quality data stored in the digital storage system 100.

In a particular aspect of the system for data lifecycle management of manufacturing test data, the system comprises an archive system for transferring decommissioned data from the digital storage system to the archive system. And the decommissioned data are no longer taken into consideration for calculating the amount of data stored in the digital storage system corresponding to the at least one type of active data.

Referring to FIG. 1A, decommissioned data are transferred from the digital storage system 100 to the archive system 120. As mentioned previously, the data stored in the digital storage system 100 may be mapped to partitions based on date range (e.g. daily, weekly, monthly). In this case, decommissioned data may be selected based on date criteria: for a certain type of data, data older than a specific date are considered obsolete and decommissioned. Then, the partition(s) corresponding to the decommissioned data are transferred from the digital storage system 100 to the archive system 120. The decommissioning process reduces the size of the database implemented by the digital storage system 100, and increases the performances of the database. For example, the performances of queries performed by the analytic system 140 are increased.

In another particular aspect of the system for data lifecycle management of manufacturing test data, the decommissioned data are selected at the digital storage system by means of one of: a user interaction with the digital storage system or an automatic enforcement of an archiving policy to the data stored in the digital storage system.

Referring to FIG. 1A, in the case of the user interaction, an administrator (or a user with administrative rights) of the digital storage system 100 manually selects the data to be decommissioned via a user interaction. For example, a Graphical User Interface may display partitions organized by dates, and the user interaction consists in selecting the partitions with obsolete data to be decommissioned. In the case of the automatic enforcement of an archiving policy, the digital storage system 100 automatically selects the data to be decommissioned, by applying the archiving policy. The archiving policy may consist in defining for various types of data stored in the digital storage system 100, a duration after which the stored data become obsolete, and should be decommissioned. The duration may vary based on each specific type of data.

In still another particular aspect of the system for data lifecycle management of manufacturing test data, decommissioned data stored in the archive system are integrated to the digital storage system in the form of near line data. And the near line data are taken into consideration when monitoring an amount of data stored in the storage system corresponding to the at least one type of active data.

Referring to FIG. 1A, near line data are a specific type of decommissioned data stored in the archive system 120. Decommissioned data can no longer be restored back in the database implemented by the digital storage system 100. However, decommissioned data stored in the archive system 120 may be integrated to the data stored in the digital storage system 100, in the form of near line data. And the near line data can be used for query and analysis purposes, for example by the analytic system 140. There may be some functional limitations on the usage of near line data for query and analysis purposes. For instance, only a subset of the near line data may be used for Online Analytic Processing (OLAP) based analysis. The near line data generally consist in huge volumes of highly compressed data, which cannot be updated (this is a major difference with the data stored in the digital storage system 100, which may be updated). The usage of near line data minimizes the storage capacity required by the digital storage system 100.

In a first embodiment, a single pre-defined alert threshold and a single pre-defined blocking threshold may be applied to all types of active data.

In a second embodiment, specific pre-defined thresholds may be applied to specific types of active data. For instance, the test data and quality data stored in the digital storage system 100 may have a specific pre-defined alert threshold and a specific pre-defined blocking threshold. And the near line data may have another specific pre-defined alert threshold and another specific pre-defined blocking threshold.

In the first embodiment, monitoring the amount of data stored in the digital storage system 100 (including the integrated near line data) corresponding to active data is performed globally for all types of active data.

In the second embodiment, monitoring the amount of data stored in the digital storage system 100 (including the integrated near line data) corresponding to active data is performed separately for each type of active data (to apply the corresponding specific pre-defined thresholds). For instance, the monitoring is performed, for the test data and quality data stored in the digital storage system 100, and for the near line data, independently.

In a particular aspect of the system for data lifecycle management of manufacturing test data, the system may further comprise a backup system for storing backup data from the digital storage system 100. Referring to FIG. 1A, the backup system 130 receives backup data from the digital storage system 100, and stores the backup data. In case of a loss of data in the digital storage system 100, backup data stored in the backup system 130 can be restored in the digital storage system 100.

The backup system 130 is different from the archive system 120. Data stored in the backup system 130 consist in operational data, which can be restored and used by the digital storage system 100. Data stored in the archive system 120 consist in decommissioned data, which cannot be restored and used by the digital storage system 100. However, the decommissioned data stored in the archive system 120 may be integrated to the digital storage system 100 in the form of near line data, and the near line data used by the digital storage system 100 (and the analytic system 140). If the near line data are considered as active data, then the amount of decommissioned data of the archive system 120 which may be integrated in the digital storage system in the form of near line data is limited by a corresponding threshold.

In a particular aspect of the system for data lifecycle management of manufacturing test data, a billing policy based on the amount of data stored in the digital storage system corresponding to the at least one type of active data is applied.

For example, the digital storage system is configured with an initial threshold for active data, and the company using the digital storage system is charged based on this initial threshold for active data. If the amount of data stored in the digital storage system corresponding to the active data reaches the initial threshold for active data, the company has two choices. First, the company may purchase additional active data storage capacity, and obtain a new threshold for active data higher than the initial threshold for active data. Alternatively, the company may decommission obsolete active data from the digital storage system, and transfer the decommissioned data to the archive system, to free some storage capacity for additional active data in the digital storage system.

Further, the pre-defined alert threshold(s) and blocking threshold may be adapted to the initial threshold for active data. For instance, if the initial threshold for active data is 500 Gigabytes, a first alert threshold may be fixed at 400 Gigabytes and a second alert threshold at 450 Gigabytes. The blocking threshold may be fixed at 525 Gigabytes (allowing a certain tolerance with respect to the 500 Gigabytes initial threshold for active data). And if a new threshold for active data is allocated, the pre-defined alert threshold(s) and blocking threshold shall be adapted accordingly.

Referring now to FIG. 1B, an acquisition unit and a digital storage system are represented.

The acquisition unit 110 represented in FIG. 1B constitutes an exemplary embodiment of an acquisition unit. The acquisition unit 110 includes a processor, a digital storage unit, and a communication interface. The processor executes instructions stored in the digital storage unit. An exemplary embodiment of the digital storage unit is one (or several) hard drive(s). Functionalities of the acquisition unit 110 are implemented by the execution of the instructions by the processor. And the acquisition unit 110 communicates with external entities (such as the digital storage system 100) via its communication interface.

The digital storage system 100 represented in FIG. 1B constitutes an exemplary embodiment of a digital storage system. The digital storage system 100 includes a processor, a digital storage unit, and a communication interface. The processor executes instructions stored in the digital storage unit. An exemplary embodiment of the digital storage unit is one (or several) hard drive(s). Functionalities of the digital storage system 100 are implemented by the execution of the instructions by the processor. And the digital storage system 100 communicates with external entities (such as the acquisition unit 110) via its communication interface. Further, the digital storage unit stores the manufacturing test data.

An exemplary embodiment (not represented in FIG. 1B) of a computer architecture of the analytic system 140, backup system 130, and archive system 120, represented in FIG. 1A is similar to the computer architecture of the acquisition unit 110 and digital storage system 100 represented in FIG. 1B.

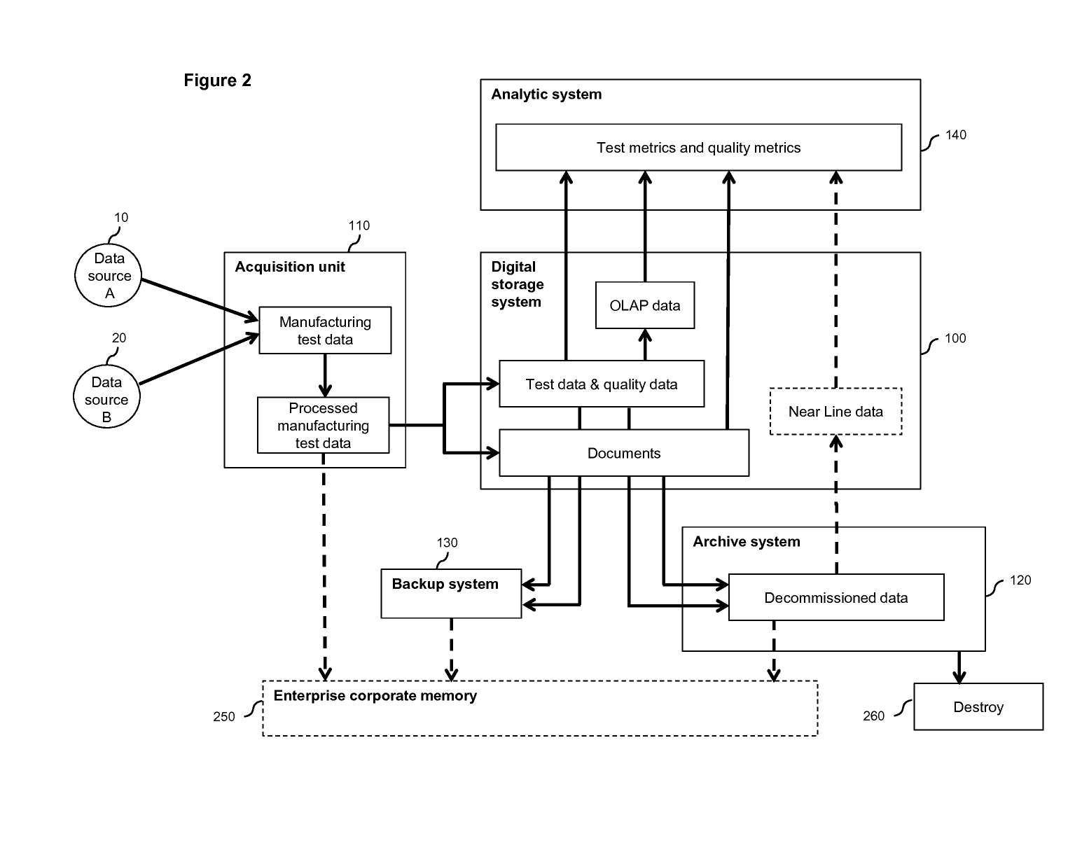

Referring now to FIG. 2, the system for data lifecycle management of manufacturing test data represented in FIG. 1A will be further detailed.

The digital storage system 100, the acquisition unit 110, the archive system 120, the backup system 130, and the analytic system 140, of FIG. 2 correspond to the matching entities represented in FIG. 1A. All these entities considered as a whole constitute a data warehouse; for receiving data, transforming the received data, storing the transformed data, and analyzing the stored data.

The acquisition unit 110 receives manufacturing test data from two data sources 10 and 20. For example, each data source may correspond to the premises of a tier I supplier (e.g. A is a tier 1 supplier and B is a tier2 supplier). Each data source 10 and 20 may include several equipment (e.g. test stations), which generate and transmit manufacturing test data to the acquisition unit 110.

The manufacturing test data consist in test data, quality data, and documents. The manufacturing test data are processed by the acquisition unit 110, and loaded in the digital storage system 100. The digital storage system 100 implements a database.

The test data and quality data may be processed by an OLAP cube, to generate OLAP data. The OLAP data are optimized data stored in the digital storage system 100, to facilitate the analysis of the data by the analytic system 140.

The analytic system 140 processes and analyses the test and quality data. These test and quality data may consist in test and quality data directly stored in the database implemented by the digital storage system 100 the OLAP data representing optimized test and quality data, and near line data containing test and quality data. The analytic system 140 also generates test metrics and quality metrics.

The test and quality data, and the documents, may be decommissioned from the digital storage system 100, and stored in the archive system 120. And decommissioned data stored in the archive system 120 may be integrated to the digital storage system 100, in the form of the near line data.

Additionally, the test and quality data, and the documents, may be stored in a backup system 130; and reintegrated from the backup system 130 to the digital storage system 100 when appropriate (e.g. in case of loss of data in the digital storage system 100). And some of the decommissioned data stored in the archive system 120 may be destroyed 260, when they are considered to be obsolete.

Also, the data warehouse system represented in FIG. 2 is deployed at the premises of an enterprise, which may have its own enterprise corporate memory 250 (for the storage and/or backup of corporate data). Thus, data from the acquisition unit 110, the backup system 130, and the archive system 120, may be further stored in the enterprise corporate memory 250.

The digital storage system 100 monitors an amount of data stored in the digital storage system 100, corresponding to following types of active data: the test data and quality data, the documents, and the near line data.

Test and quality data, and documents, which are decommissioned from the digital storage system 100 to the archive system 120, are no longer taken into consideration for calculating the amount of active data; unless they consist in near line data integrated to the digital storage system 100.

The data lifecycle management of manufacturing test data in a supply chain hierarchy, as represented in FIG. 2, comprises the following features. Receiving manufacturing test data (e.g. test data, quality data, and documents) from several members of the supply chain hierarchy at the acquisition unit 110. Processing the received manufacturing test data at the acquisition unit 110 (for rendering the received manufacturing test data compatible with the digital storage system 100). Storing the processed manufacturing test data in the digital storage system 100. Monitoring the amount of active data (e.g. test and quality data, documents, OLAP data, and near line data) stored in the digital storage system 100. Decommissioning data stored in the digital storage system 100 to the archive system 120 (and no longer considering the decommissioned data as active data). Integrating some of the decommissioned data as near line data (which are considered as active data). And further generating an alert when the amount of active data reaches a pre-defined alert threshold; and blocking access to a pre-defined subset of the data stored in the digital storage system 100 when the amount of active data reaches a pre-defined blocking threshold (for example, access to test and quality data, documents, OLAP data, and near line data, is blocked for the analytic system 140).

Although the entities represented in FIG. 2 have been described as separate units and systems, some of these entities may be implemented on a same computer, using dedicated software for implementing the functionalities of each entity. For example, the acquisition unit 110 and the digital storage system 100 may be implemented on the same computer.

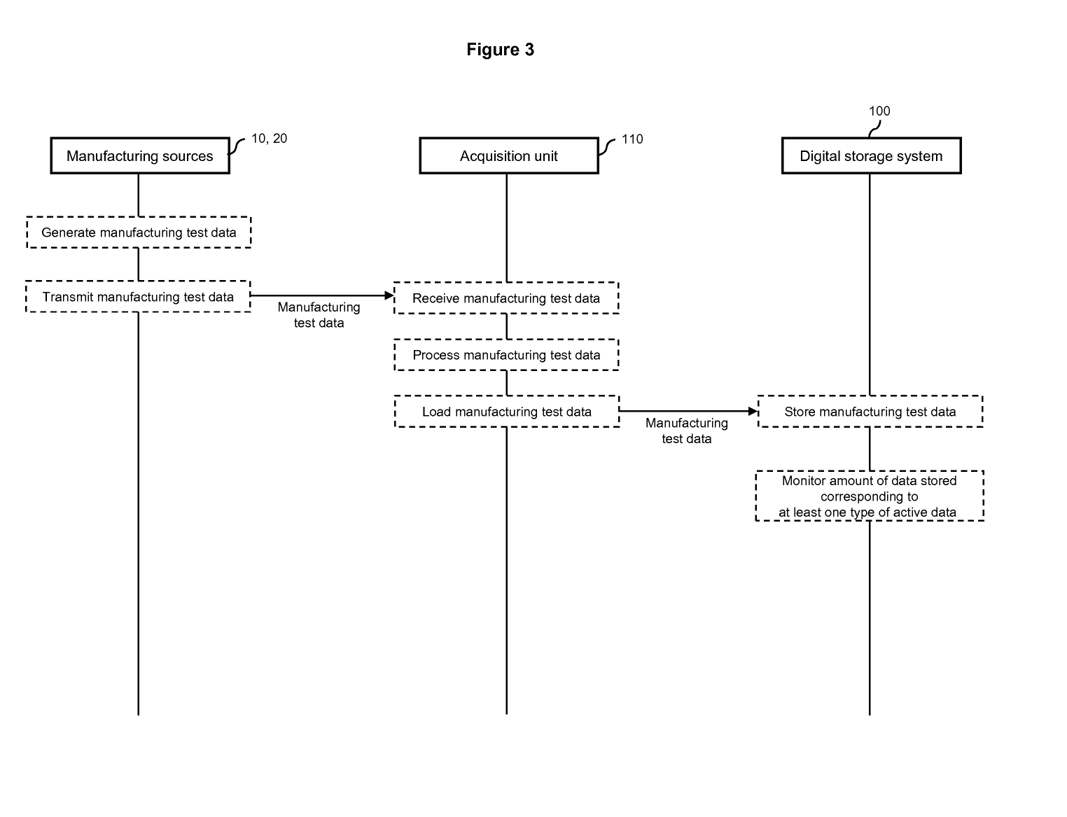

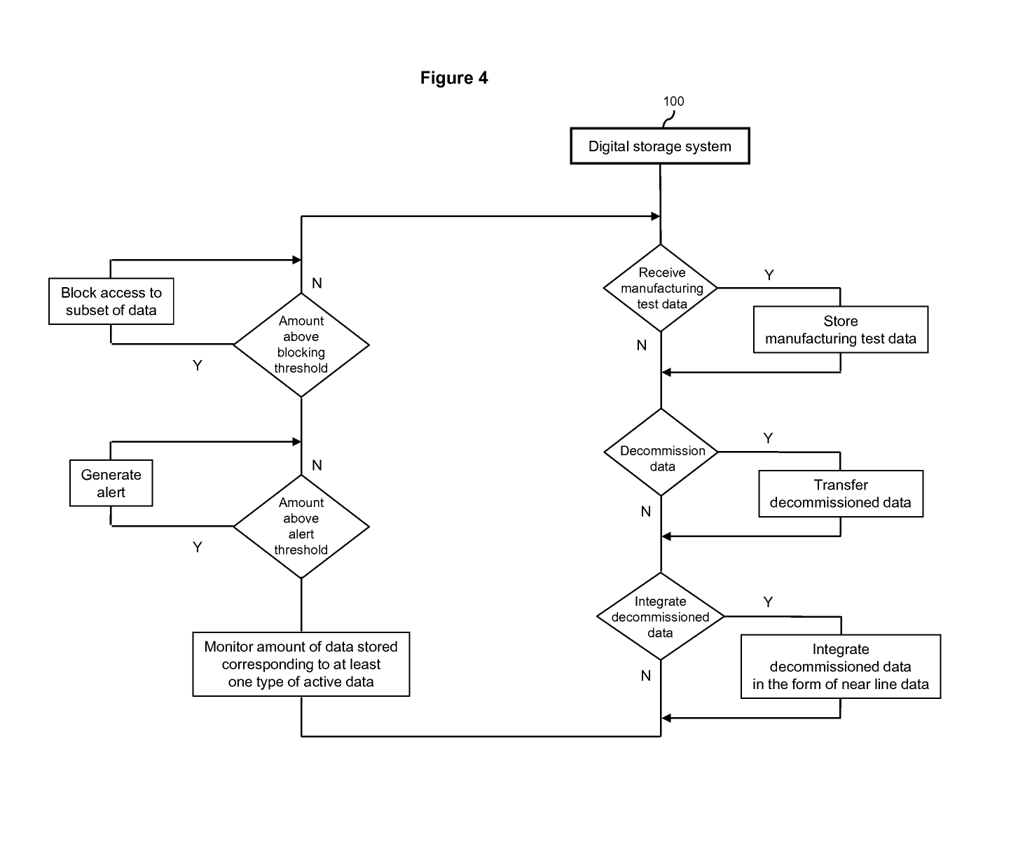

Reference is now made to FIGS. 3 and 4 concurrently. The present also relates to a method for data lifecycle management of manufacturing test data.

The method receives, at an acquisition unit, manufacturing test data from at least one source. The method processes, at the acquisition unit, the manufacturing test data for rendering the manufacturing test data compatible with a digital storage system. The method loads, at the acquisition unit, the manufacturing test data into the digital storage system. The method stores, at the digital storage system, the manufacturing test data. And the method monitors, at the digital storage system, an amount of data stored in the digital storage system corresponding to at least one type of active data.

In a particular aspect of the method, an alert is generated when the amount of data stored in the digital storage system corresponding to the at least one type of active data is above a pre-defined alert threshold.

In a particular aspect of the method, access to a pre-defined subset of data stored in the digital storage system is blocked, when the amount of data stored in the digital storage system corresponding to the at least one type of active data is above a pre-defined blocking threshold.

In a particular aspect of the method, the digital storage system implements a database for storing the manufacturing test data in an optimized format.

In another particular aspect of the method, the manufacturing test data comprise at least one of test data and quality data related to manufactured components.

In another particular aspect of the method, an analytic system processes data stored in the database, to generate at least one of test metrics and quality metrics related to the manufactured components.

In another particular aspect of the method, decommissioned data are transferred from the digital storage system to an archive system. And the decommissioned data are no longer taken into consideration, for calculating the amount of data stored in the digital storage system corresponding to the at least one type of active data.

In another particular aspect of the method, the decommissioned data are selected, at the digital storage system, by means of one of: a user interaction with the digital storage system, or an automatic enforcement of an archiving policy to the data stored in the digital storage system.

In another particular aspect of the method, decommissioned data stored in the archive system are integrated to the digital storage system, in the form of near line data. The near line data are taken into consideration, when monitoring the amount of data stored in the digital storage system corresponding to the at least one type of active data.

In a particular aspect of the method, a billing policy based on the amount of data, stored in the digital storage system, corresponding to the at least one type of active data is applied.

Referring now specifically to FIG. 4, an example of an algorithm executed by the digital storage system 100 represented in FIG. 1A, for implementing a data lifecycle management of manufacturing test data is represented.

The algorithm comprises the step of determining if manufacturing test data have been received, and in the affirmative storing the received manufacturing test data (in the digital storage system). The algorithm further comprises the step of determining if data should be decommissioned, and in the affirmative transferring the decommissioned data (to the archive system). The algorithm further comprises the step of determining if decommissioned data should be integrated, and in the affirmative integrating (to the digital storage system) the decommissioned data in the form of near line data. The algorithm further comprises the step of monitoring the amount of data stored in the digital storage system, corresponding to the at least one type of active data. The algorithm further comprises the step of determining if the amount is above an alert threshold, and in the affirmative generating an alert. And the algorithm further comprises the step of determining if the amount is above a blocking threshold, and in the affirmative blocking access to a subset of data stored in the digital storage system.

The algorithm represented in FIG. 4 is for illustration purposes only. The steps of the algorithm represented in FIG. 4 may be executed in a different order. Some steps may not be executed and/or additional steps (not represented in FIG. 4) may be executed.

Although the present disclosure has been described in the foregoing description by way of illustrative embodiments thereof, these embodiments can be modified at will, within the scope of the appended claims without departing from the spirit and nature of the appended claims.

What is claimed is:

1. A system for data lifecycle management of manufacturing test data, the system comprising:
an acquisition unit for:
receiving manufacturing test data from at least one source;
processing the manufacturing test data for rendering the manufacturing test data compatible with a digital storage system; and
loading the manufacturing test data into the digital storage system; and
the digital storage system for:
storing the manufacturing test data; and
monitoring an amount of data stored in the digital storage system corresponding to at least one type of active data.

2. The system of claim 1, wherein an alert is generated when the amount of data stored in the digital storage system corresponding to the at least one type of active data is above a pre-defined alert threshold.

3. The system of claim 1, wherein access to a pre-defined subset of data stored in the digital storage system is blocked when the amount of data stored in the digital storage system corresponding to the at least one type of active data is above a pre-defined blocking threshold.

4. The system of claim 1, wherein the digital storage system implements a database for storing the manufacturing test data in an optimized format.

5. The system of claim 4, wherein the manufacturing test data comprise at least one of test data and quality data related to manufactured components.

6. The system of claim 5 further comprising an analytic system for processing data stored in the database to generate at least one of test metrics and quality metrics related to the manufactured components.

7. The system of claim 4 further comprising an archive system for transferring decommissioned data from the digital storage system to the archive system; wherein the decommissioned data are no longer taken into consideration for calculating the amount of data stored in the digital storage system corresponding to the at least one type of active data.

8. The system of claim 7, wherein the decommissioned data are selected at the digital storage system by means of one of: a user interaction with the digital storage system or an automatic enforcement of an archiving policy to the data stored in the digital storage system.

9. The system of claim 7, wherein decommissioned data stored in the archive system are integrated to the digital storage system in the form of near line data; wherein the near line data are taken into consideration when monitoring the amount of data stored in the digital storage system corresponding to the at least one type of active data.

10. The system of claim 1, wherein a billing policy based on the amount of data stored in the digital storage system corresponding to the at least one type of active data is applied.

11. A method for data lifecycle management of manufacturing test data, the method comprising:
receiving at an acquisition unit manufacturing test data from at least one source;
processing at the acquisition unit the manufacturing test data for rendering the manufacturing test data compatible with a digital storage system;
loading at the acquisition unit the manufacturing test data into the digital storage system;
storing at the digital storage system the manufacturing test data; and
monitoring at the digital storage system an amount of data stored in the digital storage system corresponding to at least one type of active data.

12. The method of claim 11, wherein an alert is generated when the amount of data stored in the digital storage system corresponding to the at least one type of active data is above a pre-defined alert threshold.

13. The method of claim 11, wherein access to a pre-defined subset of data stored in the digital storage system is blocked when the amount of data stored in the digital storage system corresponding to the at least one type of active data is above a pre-defined blocking threshold.

14. The method of claim 11, wherein the digital storage system implements a database for storing the manufacturing test data in an optimized format.

15. The method of claim 14, wherein the manufacturing test data comprise at least one of test data and quality data related to manufactured components.

16. The method of claim 15, wherein an analytic system processes data stored in the database to generate at least one of test metrics and quality metrics related to the manufactured components.

17. The method of claim 14, wherein decommissioned data are transferred from the digital storage system to an archive system, and the decommissioned data are no longer taken into consideration for calculating the amount of data stored in the digital storage system corresponding to the at least one type of active data.

18. The method of claim 17, wherein the decommissioned data are selected at the digital storage system by means of one of: a user interaction with the digital storage system or an automatic enforcement of an archiving policy to the data stored in the digital storage system.

19. The method of claim 17, wherein decommissioned data stored in the archive system are integrated to the digital storage system in the form of near line data; wherein the near line data are taken into consideration when monitoring the amount of data stored in the digital storage system corresponding to the at least one type of active data.

20. The method of claim 11, wherein a billing policy based on the amount of data stored in the digital storage system corresponding to the at least one type of active data is applied.
